(19) United States
(12) Patent Application Publication
(10) Pub. No.: US 2011/0174854 A1
(43) Pub. Date: Jul. 21, 2011

(54) TISSUE PAPER BOX HOLDER

(76) Inventor: Shun-Te LIANG, Beigang Township (TW)

(21) Appl. No.: 12/688,448

(22) Filed: Jan. 15, 2010

(51) Int. Cl. B60R 7/05

(52) U.S. Cl. 224/312

(57) ABSTRACT

A tissue paper box holder has two parallel vertical bars, a clip part taking a U-like form and formed by extending the two vertical bars rearwardly, and two longitudinal bars formed by extending rearwardly from a bottom end of a neighboring vertical bar and maintaining distances relative to the clip part progressively decreasing rearwardly. When a tissue paper box is held by the tissue paper box holder, the tissue paper box can be directly mounted on a sun visor of a front seat of a vehicle for front seat passengers to draw out the tissue paper.

### BACKGROUND OF THE INVENTION

1. Field of the Invention

The present invention is related to a tissue paper box holder, and more particularly to a tissue paper box holder capable of being securely mounted on a sun visor for a front seat of a vehicle.

2. Description of the Related Art

Tissues papers could be one of the most frequently used commodities of daily life. Tissue paper boxes could be ubiquitous regardless of the occasions one goes, for example, offices, dinning tables and inside vehicles.

When placed in a vehicle and on a dashboard for front seat passengers, a tissue paper box could be traveled to left or right on the dashboard or even fall out the dashboard depending on driving conditions. Such movements of the tissue paper box are annoying, distract driver's attention and possibly put driver in danger. When a tissue paper box is placed in the back of a vehicle, tissue papers could be only passed through from back seat passengers. Hence, inconvenience and driving safety arise from the placement of tissue paper boxes inside a vehicle.

In response to the concern, a conventional tissue paper box bracket is mounted near front seats of a vehicle to hold a tissue paper box. However, the tissue paper box bracket partially blocks driver's view and jeopardize driver's safety accordingly. As a result, the conventional tissue paper box bracket has to be further refined.

### SUMMARY OF THE INVENTION

An objective of the present invention is to provide a tissue paper box holder capable of being securely mounted on a sun visor for a front seat of a vehicle.

To achieve the foregoing objective, the tissue paper box holder has two vertical bars, a clip part and two longitudinal bars.

The clip part takes a U-like form and has two arms and a curved portion. The two arms respectively extend rearwardly from top ends of the two vertical bar. The curved portion has two ends respectively connected with the two arms.

Each longitudinal bar has a first end connected with a neighboring vertical bar and a second end, extends rearwardly from a bottom end of the neighboring vertical bar, and maintains distances relative to a neighboring arm progressively decreasing from the first end to the second end.

When a tissue paper box is held by the tissue paper box holder, the tissue paper box can be mounted on the sun visor of the front seat of the vehicle by inserting the sun visor into a gap between the clip part of the tissue paper box holder and the tissue paper box, thereby conveniently allow front seat passengers to draw out the tissue paper in the tissue paper box.

### BRIEF DESCRIPTION OF THE DRAWINGS

FIG. 1 is a perspective view of a first preferred embodiment of a tissue paper box holder in accordance with the present invention;

FIG. 2 is a perspective view of a second preferred embodiment of a tissue paper box holder in accordance with the present invention;

FIG. 3 is a perspective view of a third preferred embodiment of a tissue paper box holder in accordance with the present invention;

FIG. 4 is a perspective view of a fourth preferred embodiment of a tissue paper box holder in accordance with the present invention;

FIG. 5 is a perspective view of a fifth preferred embodiment of a tissue paper box holder in accordance with the present invention;

FIG. 6 is a first perspective view of a sixth preferred embodiment of a tissue paper box holder in accordance with the present invention;

FIG. 7 is a second perspective view of the sixth preferred embodiment of the tissue paper box holder in accordance with the present invention and a tissue paper box before the tissue paper box is held by the tissue paper box holder;

FIG. 8 is a third perspective view of the sixth preferred embodiment of the tissue paper box holder in accordance with the present invention and the tissue paper box after the tissue paper box is held by the tissue paper box holder;

FIG. 9 is a fourth perspective view of the sixth preferred embodiment of the tissue paper box holder in accordance with the present invention and the tissue paper box after the tissue paper box is held by the tissue paper box holder;

FIG. 10 is a schematic view of the sixth preferred embodiment of the tissue paper box holder mounted on a sun visor of a vehicle; and

FIG. 11 is an enlarged side view in FIG. 10.

### DETAILED DESCRIPTION OF THE INVENTION

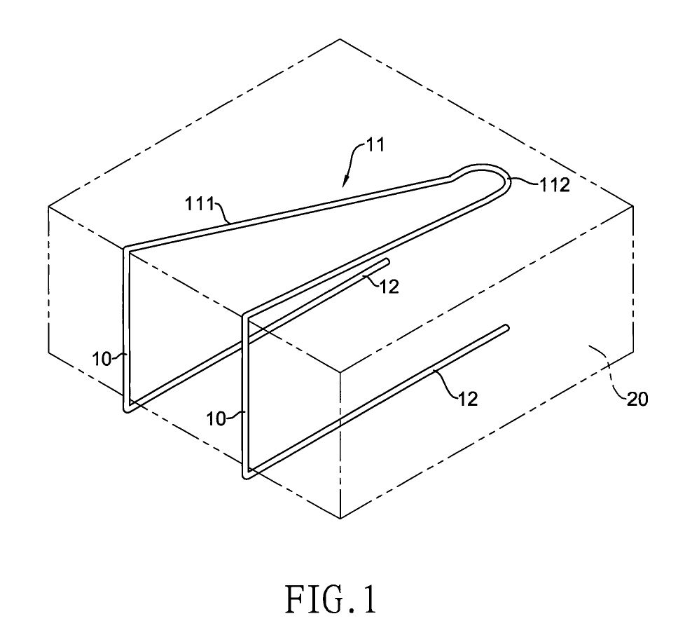

With reference to FIG. 1, a first embodiment of a tissue paper box holder in accordance with the present invention has two vertical bars (10), a clip part (11) and two longitudinal bars (12). The two vertical bars (10) are parallel. The clip part (11) takes a U-like form and has two arms (111) and a curved portion (112). The two arms extend rearwardly from respective top ends of the two vertical bars (10) and gradually converge. The curved portion (112) has two ends respectively connected with the two arms (111) and is slightly bent upwardly relative to the two arms (111). Each longitudinal bar (12) has a first end and a second end, and the first end is connected with a neighboring vertical bar (10). Each longitudinal bar (12) is formed by rearwardly extending from a bottom end of the connected vertical bar (10), and maintains distances relative to a neighboring arm (111) progressively decreasing from the first end to the second end so that a tissue paper box (20) can be held between the clip part (11) and the two longitudinal bars (12).

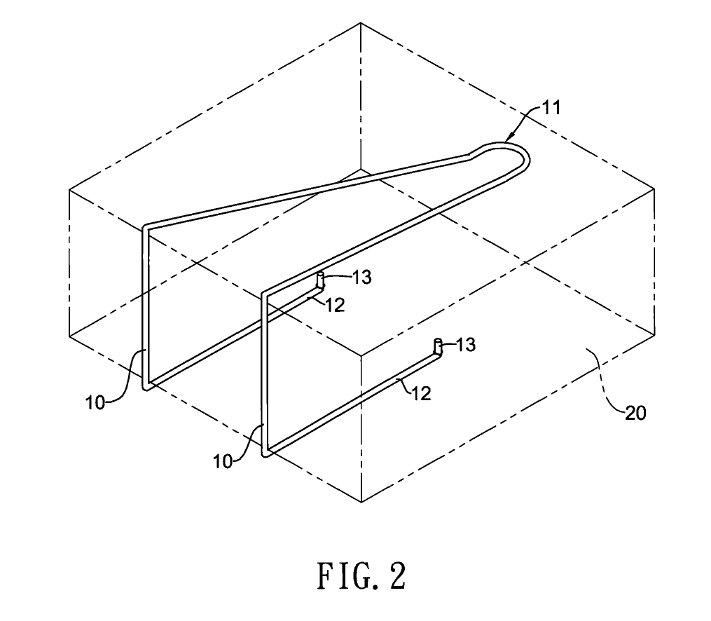

With reference to FIG. 2, a second embodiment of a tissue paper box holder in accordance with the present invention differs from the first embodiment in that the two longitudinal bars (12) are shorter than the clip part (11), and each longitudinal bar (12) has a first insert end (13) formed by perpendicularly extending upwardly from the second end thereof. The two first insert ends (13) serve to insert in a bottom side of the tissue paper box (20) and fix the tissue paper box (20).

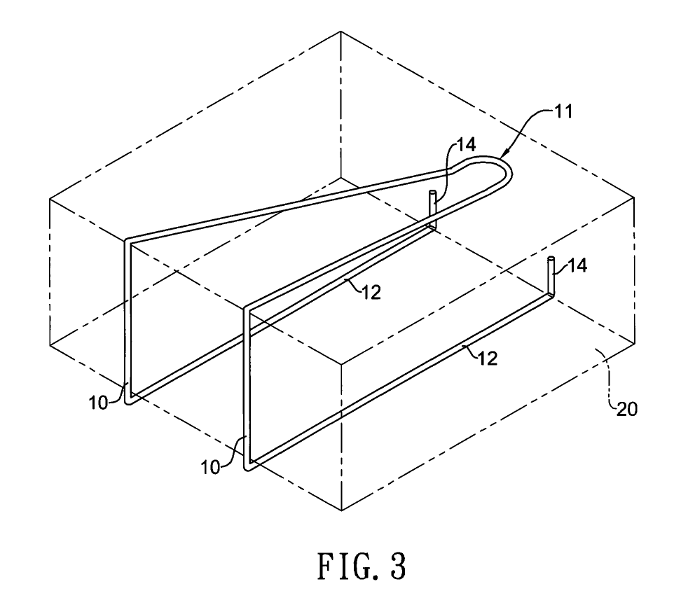

With reference to FIG. 3, a third embodiment of a tissue paper box holder in accordance with the present invention differs from the first embodiment in that lengths of the two longitudinal bars (12) are equivalent to a length of the clip part (11), and each longitudinal bar has a stop end (14) formed by perpendicularly extending upwardly from the second end thereof. The two stop ends (14) serve to abut against a rear side of the tissue paper box (20) and further limit the tissue paper box (20) between the clip part (11) and the two longitudinal bars (12).

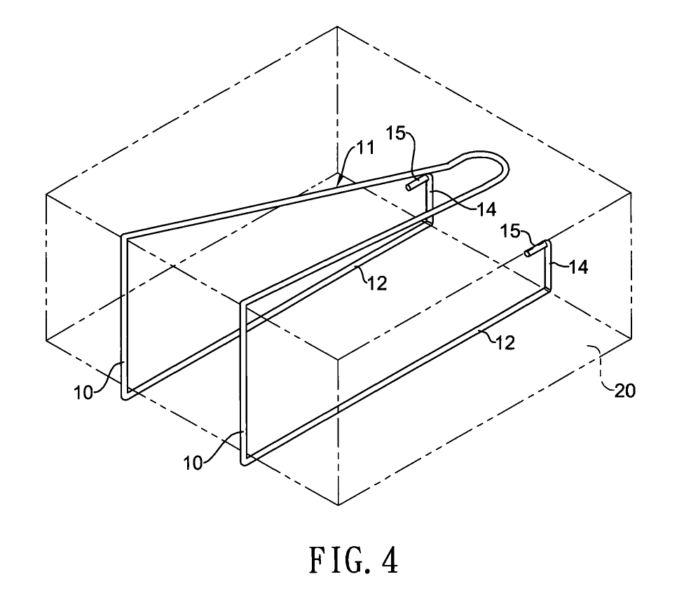

With reference FIG. 4, a fourth embodiment of a tissue paper box holder in accordance with the present invention differs from the third embodiment in that each longitudinal bar (12) has a second insert end (15) perpendicularly extending forwardly from a free end of the stop end (14) thereof. The rear side of the tissue paper box (20) is inserted by the two second insert ends and held by the two stop ends (14) so as to push a front side of the tissue paper box (20) against the vertical bars (10) and limit the tissue paper box (20) between the clip part (11) and the two longitudinal bars (12).

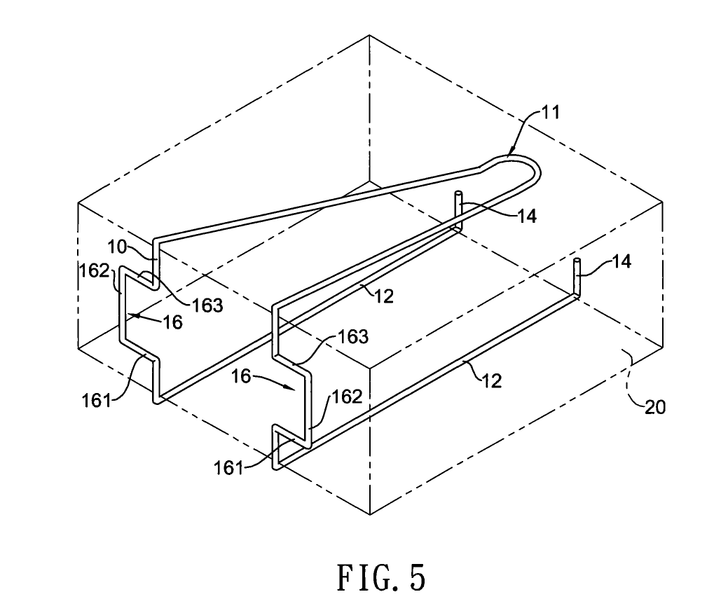

With reference to FIG. 5, a fifth embodiment of a tissue paper box holder in accordance with the present invention differs from the third embodiment in that each vertical bar (10) has a first ear portion (16) having a first segment (161) and a third segment (163) respectively bent to extend laterally from two positions of the vertical bar (10) and a second segment (162) connected with the first segment (161) and the third segment (163). The two first ear portions (16) are symmetrical and serve to abut against the front side of the tissue paper box (20) and limit the tissue paper box (20) between the clip part (11) and the two longitudinal bars (12).

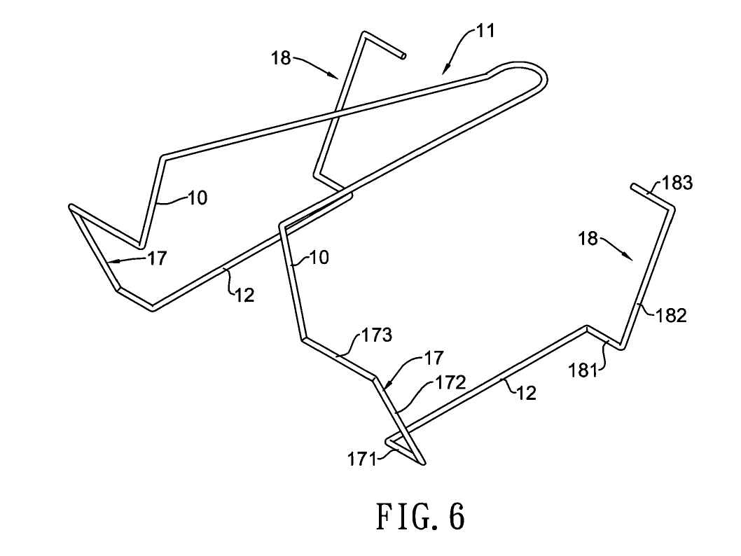

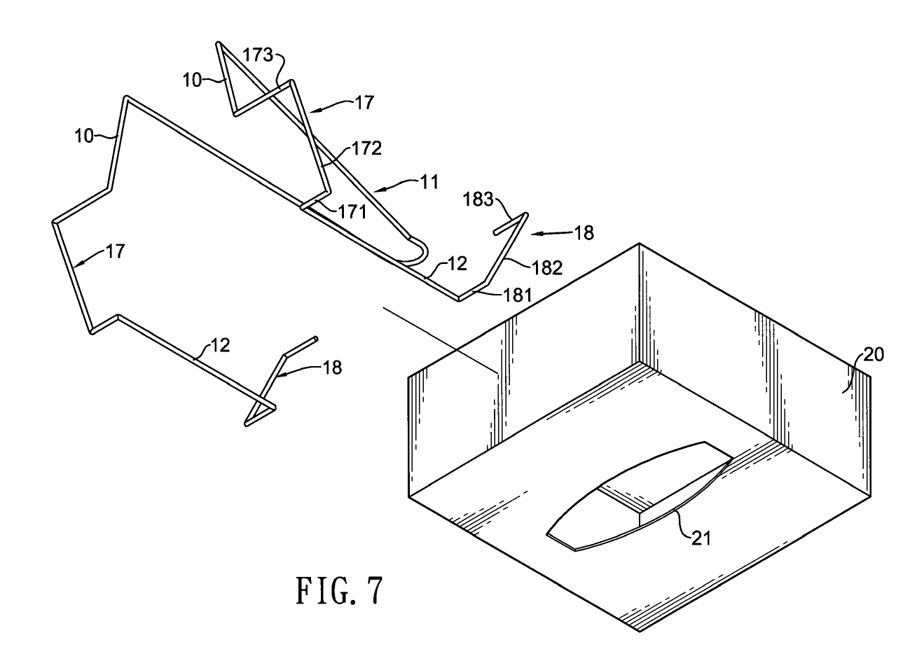

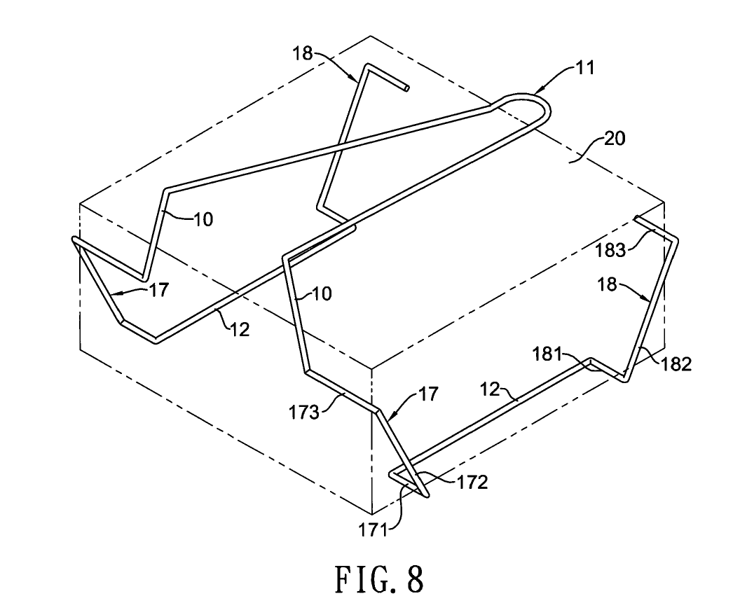

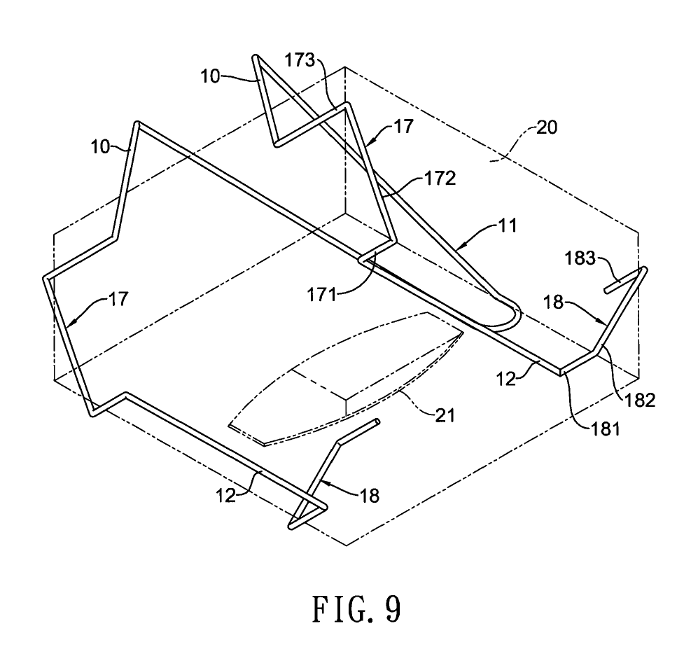

With reference to FIGS. 6 to 9, a sixth embodiment of a tissue paper box holder in accordance with the present invention differs from the first embodiment in that distances between the two vertical bars (10) progressively increase from top ends to bottom ends of the two vertical bars (10). Each vertical bar (10) has a second ear portion (17). The second ear portion (17) has a first segment (171), a second segment (172) and a third segment (173). The first segment (171) is bent to extend laterally from the bottom end of the vertical bar (10). The third segment (173) is bent to extend laterally from a position between the top end and the bottom end of the vertical bar (10). The second segment (172) is connected with the first segment (171) and the third segment (173). The two second ear portions (17) are symmetrical. Each longitudinal bar (12) has a third ear portion (18). The third ear portion (18) has a first segment (181), a second segment (182) and a third segment (183). The first segment (181) is bent to extend laterally from a position between the first end and the second end of the longitudinal bar (12). The second segment (182) is connected with the first segment (181) and is bent to extend upwardly and rearwardly. The third segment (183) is connected with the second segment (182) and is bent to extend in a direction reverse to the extending direction of the first segment (181). The two third ear portions (18) are symmetrical. When the tissue paper box (20) is inserted in the tissue paper box holder, the first, second and third segments (171, 172, 173) of each second ear portion (17) respectively abut against a bottom surface, a side surface and a front surface of a bottom corner in the front of the tissue paper box (20), and the first, second and third segments (181, 182, 183) of each third ear portion (18) respectively abut against a bottom surface, a side surface and a rear surface of a bottom corner in the back of the tissue paper box (20). Therefore, the tissue paper box (20) are held firmly by the two second ear portions, the two third ear portions, the clip part (11) and the two longitudinal bars (12).

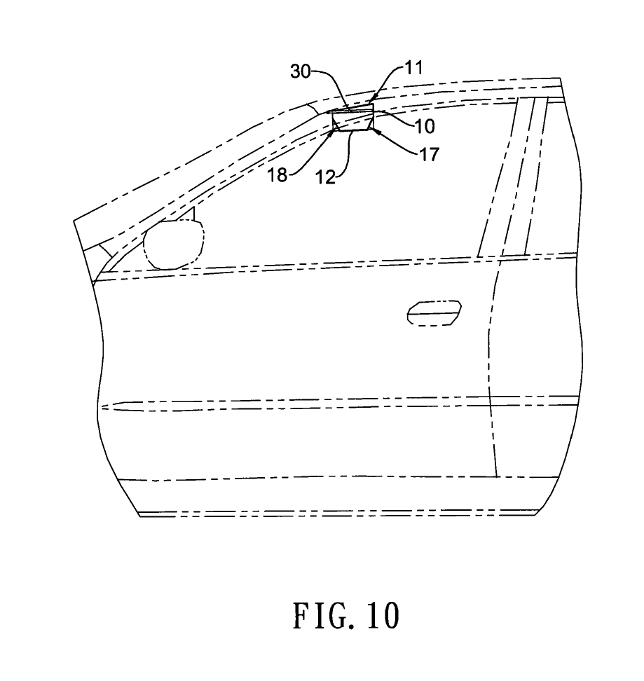

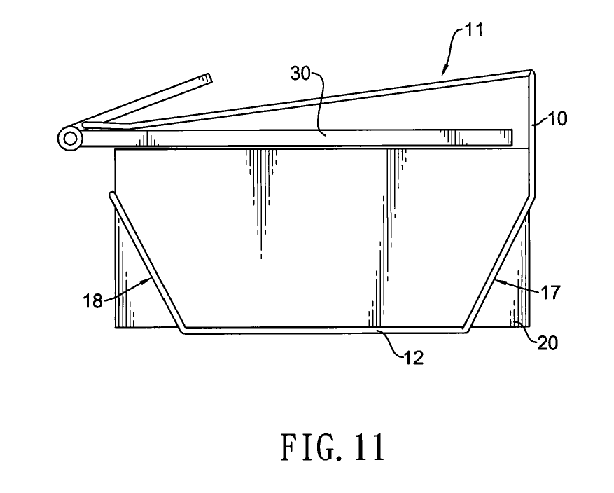

With reference to FIGS. 10 and 11, when the tissue paper box (20) is held by the tissue paper box holder, the sun visor (30) of a front seat of a vehicle can be inserted in a gap between the tissue paper box (20) and the clip part (11) of the tissue paper holder. So, a paper outlet (21) of the tissue paper box (20) facing front seat passengers allows the front seat passengers to conveniently draw out tissue paper at any time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A tissue paper box holder, comprising:
two vertical bars;
a clip part taking a U-like form and having
two arms respectively extending rearwardly from top ends of the two vertical bar; and
a curved portion having two ends respectively connected with the two arms; and
two longitudinal bars, each longitudinal bar having
a first end connected with a neighboring vertical bar; and
a second end, extending rearwardly from a bottom end of the neighboring vertical bar;
and maintaining distances relative to a neighboring arm progressively decreasing from the first end to the second end.

2. The tissue paper box holder as claimed in claim 1, wherein the two vertical bars are parallel.

3. The tissue paper box holder as claimed in claim 2, wherein the two longitudinal bars are shorter than the clip part, and each longitudinal bar has a first insert end formed by perpendicularly extending upwardly from the second end thereof.

4. The tissue paper box holder as claimed in claim 2, wherein lengths of the two longitudinal bars equal to a length of the clip part, and each longitudinal bar has a stop end formed by perpendicularly extending upwardly from the second end thereof.

5. The tissue paper box holder as claimed in claim 4, wherein each longitudinal bar has a second insert end perpendicularly extending forwardly from a free end of a stop end thereof.

6. The tissue paper box holder as claimed in claim 1, wherein each vertical bar has a first ear portion bent to extend laterally from the vertical bar, and the two first ear portions are symmetrical.

7. The tissue paper box holder as claimed in claim 2, wherein each vertical bar has a first ear portion bent to extend laterally from the vertical bar, and the two first ear portions are symmetrical.

8. The tissue paper box holder as claimed in claim 3, wherein each vertical bar has a first ear portion bent to extend laterally from the vertical bar, and the two first ear portions are symmetrical.

9. The tissue paper box holder as claimed in claim 4, wherein each vertical bar has a first ear portion bent to extend laterally from the vertical bar, and the two first ear portions are symmetrical.

10. The tissue paper box holder as claimed in claim 5, wherein “each vertical bar has a first ear portion each vertical bar has a first ear portion”? bent to extend laterally from the vertical bar, and the two first ear portions are symmetrical.

11. The tissue paper box holder as claimed in claim 1, wherein distances between the two vertical bars progressively increase from top ends to bottom ends of the two vertical bars, wherein
each vertical bar has a second ear portion bent to extend laterally and having one end connected with the bottom end of the vertical bar, wherein the two second ear portions are symmetrical;
each longitudinal bar has a third ear portion bent to extend laterally, upwardly and rearwardly and having one end connected with the second end of the longitudinal bar, wherein the two third ear portions are symmetrical.

12. The tissue paper box holder as claimed in claim 6, wherein the curved portion of the clip part is slightly bent upwardly relative to the corresponding arm of the clip part.

13. The tissue paper box holder as claimed in claim 7, wherein the curved portion of the clip part is slightly bent upwardly relative to the corresponding arm of the clip part.

14. The tissue paper box holder as claimed in claim 8, wherein the curved portion of the clip part is slightly bent upwardly relative to the corresponding arm of the clip part.

15. The tissue paper box holder as claimed in claim 9, wherein the curved portion of the clip part is slightly bent upwardly relative to the corresponding arm of the clip part.

16. The tissue paper box holder as claimed in claim 10, wherein the curved portion of the clip part is slightly bent upwardly relative to the corresponding arm of the clip part.

17. The tissue paper box holder as claimed in claim 11, wherein the curved portion of the clip part is slightly bent upwardly relative to the corresponding arm of the clip part.
